(19) United States
(12) Patent Application Publication
(10) Pub. No.: US 2006/0226762 A1
(43) Pub. Date: Oct. 12, 2006

(54) Image display apparatus and a method for manufacturing thereof

(76) Inventors: Toshio Sasamoto, Hamura (JP); Noriyuki Oroku, Yokohama (JP); Yoshie Kodera, Chigasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/367,296

(22) Filed: Mar. 6, 2006

(30) Foreign Application Priority Data
Apr. 8, 2005 (JP) 2005-111879

(51) Int. Cl. H01J 63/04

(52) U.S. Cl. 313/495

(57) ABSTRACT

In a method for manufacturing an image display apparatus, in which a rear substrate and a front substrate are adhered and fixed at a predetermined positional relationship, with high productivity, two (2) lines of seal flit glass FT are applied on inner surfaces of the rear substrate SUB1 and the front substrate SUB2, where a sealing frame FR is bonded and fixed, along the frame sides, on both sides of an abutting surface (i.e., a vacuum side and an atmospheric side) of the sealing frame FR, and are baked, provisionally. The sealing frame FR is disposed between those two (2) lines of seal flit glass FT, and is baked, thereby melting down the seal flit glass for bonding and fixing thereof.

### BACKGROUND OF THE INVENTION

1. Field of the Invention

The present invention relates to an image display apparatus and also a method for manufacturing thereof, and in particular, it relates to an image display apparatus of flat-panel type, hermetically keeping an interior space enclosed to be lower in pressure than that of an outside thereof, and a manufacturing method thereof, as well.

2. Description of the Related Art(s)

Conventionally, a color cathode ray tube (CRT) is widely used as an image display apparatus, being superior in high brightness and also high definition. However, accompanying with the current tendencies of high picture quality in recent years, in particular, within a filed of the information processing apparatuses and also the television broadcastings, demands are increasing upon a plate-like (or, a panel-type) image display apparatus (FDP: a Flat Panel Display), being light-weighted and space saving, as well as, having high brightness and high definition.

As a typical example of such, a liquid crystal display apparatus and a plasma display apparatus, etc., are put into practical uses thereof. Also, in near future, various types of the panel-type display apparatuses will be put into practical uses thereof, such as, an field (or electron) emission display (hereinafter, also being called by “FED”), in particular, that for enabling to achieve the high brightness, and also an organic EL display, having a characteristic of low consumption of electricity.

In relation to the FED, the conventional arts are already known in, such as, Japanese Patent Laying-Open No. Hei 9-283059 (1997), Japanese Patent Laying-Open No. 2000-21335 (2000), and Japanese Patent Laying-Open No. Hei 8-22782 (1996), for example. Those conventional arts disclose an opposite arrangement of panels at a predetermined distance therebetween; i.e., a rear (or rear-surface) panel, forming a plural number of electron sources on an inner surface thereof, and a front (or, front-surface) panel, facing to the electron sources formed on the surface of the rear-surface panel, which forms anodes and fluorescent substance on an inner surface thereof. Further, there is also disclosed the structures of providing an outer frame along an inner edge portion on the outer periphery of the rear panel or the front panel, wherein the rear panel and the front panel are stuck of affixed to each other through that outer frame, thereby obtaining a vacuum vessel within an inside thereof.

### SUMMARY OF THE INVENTION

FIGS. 11(a) and 11(b) are views for explaining an example of the image display apparatus according to the present invention. FIG. 11(a) shows a plane view thereof, seen from a side of the front substrate, while FIG. 11(b) shows a cross-section view when being cut along a line A-A′ in FIG. 11(a), respectively.

This image display apparatus is constructed with a rear panel and a front panel, facing to each other keeing a predetermined gap or distance therebetween. The rear panel has an insulator substrate (hereinafter, being called “rear substrate SUB1”), preferably made from a material, such as, a glass plate, on an interior surface of which are formed a large number of electron discharge sources (hereinafter, being called “cathode”). The front panel has an insulator substrate (hereinafter, being called “front substrate SUB2), being made from a transparent glass plate, on an interior surface of which, facing to the cathode forming surface of the rear substrate SUB1, are formed a black matrix and fluorescent substance and anodes, etc., (hereinafter, being called “anode”, collectively).

The rear substrate SUB1 and the front substrate SUB2 are disposed through a space holding member (i.e., a spacer SPC), f acing to each other at a predetermined distance therebetween. And, after applying seal frit glass FT along an interior edge portion on the outer periphery thereof, so as to insert a sealing frame between them, the rear substrate SUB1 and the front substrate SUB2 are baked and fixed to each other, thereby forming a vacuum vessel (i.e., the enclosed space) therein. This vacuum vessel is vacuumed through a vacuum tube not shown in the figure.

The seal frit glass FT for adhering the sealing frame FR is made of a glass paste, having viscosity of about 100 Pa·s or higher than that, which is obtained through pasting glass powder having an averaged particle size from 3 μm to 10 μm, for example, together with a solvent having a desired viscosity. This is applied on the rear substrate SUB1 and the front substrate SUB2, through the screen printing, the dispense method, or the Cotar batch print, etc., and is baked under temperature 500° C.-580° C. after being dried. With this, the flit glass being melted while dispersing the solvent adheres the rear substrate SUB1 and the front substrate SUB2 through the sealing frame FR, or putting the sealing frame FR between them, thereby fixing them into one body.

In such the image display apparatus, signal lines are extended into “y” direction (i.e., into up-and-down direction in FIG. 11(a)) in a large number thereof, and in parallel with in “x” direction (i.e., into right-and-left direction in FIG. 11(a)). Also, scanning lines are extended into the “x” direction crossing those signal lines, in parallel with in the “y” direction. Driving signals onto the scanning lines are applied from scanning line driver circuits (or, gate drivers) GDR(1) and GDR(2), which are mounted on both sides in FIG. 11(a), respectively. The signal lines are driven by means of a signal line driver circuit (or, a data drivers) DDR, which is mounded in an upside in FIG. 11(a). However, for simplifying the explanation, FIG. 11(a) shows the scanning line driver circuits on both sides and also the signal line driver circuit, respectively, only by a one (1) piece thereof (i.e., in many cases, the signal line driver circuit may be mounted in a downside in FIG. 11(a)).

The spacers SPCs, each made from a thin glass plate preferably, are planted on the scanning lines, along the longitudinal direction of the scanning lines, directing the width into a “z” direction, and thereby maintaining the gap between the rear substrate SUB1 and the front substrate SUB2 at a predetermined value. In FIG. 11(a), though only four (4) pieces of the spacers SPCs are provided along the longitudinal direction of each of the scanning lines, however this is only an example thereof. The number of spacers SPCs disposed, the distance between them and so on, they are determined depending on the material, board thickness and resolution, etc., of the rear substrate SUB1 and the front substrate SUB2.

FIG. 12 is a typical cross-section view for showing the condition just before the rear substrate and the front substrate are fixed, putting the sealing frame between them while adhering them through the seal flit glass. In this FIG. 12, when assembling rear substrate SUB1 and the front substrate SUB2 with putting the sealing frame FR between them, the seal flit glass FT is applied on the rear substrate SUB1 and the front substrate SUB2, only a one (1) line, by means of a one (1) piece of a dispenser. Herein, the spacer SPC are provisionally fixed on a side of the front substrate SUB2, in advance. The applied seal flit glass is dried, and thereafter it is baked under low temperature, provisionally. The rear substrate SUB1 and the front substrate SUB2 are affixed under the condition of putting the sealing frame FR between them through the seal flit glasses FTs, which are baked provisionally. This is put into a baking furnace, whereby melting the seal flit glasses FTs, so as to weld the sealing frame FR and the rear substrate SUB1 and the front substrate SUB2.

However, for keeping a desired width and a necessary amount of application of the seal flit glass, which is applied by means of the one (1) piece of the dispenser, it is necessary to use a material for the seal flit glass, which has a relatively high viscosity thereof. The seal flit glass FT, obtained through application, drying and provisional baking of the seal flit glass FT, in this manner, comes to be a semicircle in the cross-section thereof. For this reason, there sometimes occurs the case where the sealing frame FR that abutting thereon through the melding seal flit glasses FTs is shifted, or the rear substrate SUB1 and the front substrate SUB2 are shifted in the relative position therebetween.

FIG. 13 is a typical cross-section view for showing the condition where the sealing frame FR is shifted when the seal flit glass melts. This condition shows that where fall (or inclination) is generated on the sealing frame FR. The rear substrate SUB1 and the front substrate SUB2 are affixed under the condition of putting the sealing frame FR between them through the seal flit glasses FTs, which are baked provisionally. This is put into the baking furnace, and when welding the sealing frame FR and the rear substrate SUB1 and the front substrate SUB2, through melting the seal flit glass FT, suppressing pressure is applied between the both substrates, for keeping the distance between the rear substrate SUB1 and the front substrate SUB2 at the predetermined value determined by means of the heights of the sealing frame FR and the spacer SPCs.

In this instance, but sometimes, the sealing frame FR, riding on the seal flit glass FT and being semicircular-like in the cross-section before melting, is not always melted down, simultaneously and uniformly. For this reason, the sealing frame FR is sometimes shifted from the predetermined position thereof. Also, since the sealing frame FR is thin in the thickness thereof, it sometimes occurs to fall down partially. As a result thereof, the followings occur, i.e., the spacers SPCs, being applied with an unreasonable force in the width direction thereof, are broken down, and the rear substrate SUB1 and the front substrate SUB2 are not fixed with keeping them at the predetermined distance therebetween. Almost of such the image display apparatuses, which are assembled in this manner, result into defective ones.

FIG. 14 is a typical cross-section view for showing the condition where the front substrate SUB2 is moved in parallel with the rear substrate SUB1 when the seal flit glass melts down. Within the process of melting the seal flit glass FT in the baking furnace mentioned above, there is a case where the said seal flit glass does not melt down, simultaneously and uniformly. In that instance, the front substrate SUB2 is slid into the horizontal direction, as is shown by an arrow, and thereby being fixed under the condition as shown in FIG. 14. All of the image display apparatuses, which are assembled in this manner, are high in the provability that they are defective ones.

FIGS. 15(a) and 15(b) are perspective views for explaining a method for assembling the rear substrate and the front substrate, with using the sealing frame. FIG. 15(a) shows a method of affixing the rear substrate SUB1 and the front substrate SUB2, with applying the seal flit glass FT on a side of the front substrate SUB2, in the similar manner shown in FIGS. 11(a) and 11(b) through FIG. 14. And, FIG. 15(b) shows a method, on the contrary to the above, of applying the seal slit glass FT on both sides of the sealing frame FR. In this method, but the processes of applying the seal flit glass, drying, provisional baking, affixing of the rear substrate SUB1 and the front substrate SUB2, and fixing through melting in the baking furnace are similar to those in FIG. 15(a).

According to the present invention, there is provided an image display apparatus, in which the rear substrate and the front substrate are fixed at the predetermined positional relationship, potting the sealing frame therebetween, with using the seal flit glass, and also a technology for increasing the productivity thereof.

Within the image display apparatus, according to the present invention, a first substrate (i.e., the rear substrate) and a second substrate (i.e., the front substrate) are bonded and fixed through two (2) lines of the seal flit glass, which are applied on interior surfaces of the first substrate and the second substrate, upon which surfaces is bonded and fixed a sealing frame on both surfaces thereof, along frame sides of said sealing frame, on both abutting sides thereof (i.e., the vacuum side and the atmosphere side).

With the image display apparatus, according to the present invention, it is possible to form a film of the seal flit glass, being thinner than the film thickness of said the two (2) lines of the seal flit glass contacting on the abutting surface of the sealing frame, between the said two (2) lines of the sealing flit glasses.

Also, with the image display apparatus, according to the present invention, one of the said two (2) lines of the seal flit glass may be made of a crystalline material, which crystallized under temperature lower than the other seal flit glass. And, it is also possible to make up the other seal flit glass of a non-crystalline material. Further, it is also possible to make up the thin seal flit glass of the material, being same to the seal flit glass of the one mentioned above, or the seal fit glass of the other one.

With the image display apparatus, according to the present invention, it is possible to position the above-mentioned one of the seal flit glass inside said two (2) liens on the abutting surface mentioned above.

Also, within a method for manufacturing an image display apparatus according to the present invention, two (2) lines of seal flit glass are applied on the inner surfaces of said first substrate and said second substrate, where said sealing frame is bonded and fixed, along both sides (i.e., a vacuum side and an atmospheric side) on abutting areas of said sealing frame; the seal flit glasses applied is dried, and then baked, provisionally, so as to remove a solvent therefrom; said first substrate and said second substrate are piled up, with putting said sealing frame between them, so that said sealing frame is positioned between the said two (2) lines of seal flit glass, facing to each other; said first substrate and said second substrate piled up with putting said seal frame therebetween are baked under temperature higher than said provisional baking; and said seal flit glass is melted for bonding thereof.

Within the method for manufacturing an image display apparatus, according to the present invention, a seal flit glass film may be applied between said two (2) lines of seal flit glass, being thinner than film thickness of said two (2) lines of seal flit glass, which are in contact with said abutting areas of said sealing frame.

And, within a method for manufacturing an image display apparatus according to the present invention, two (2) lines of seal flit glass are applied on the inner surfaces of said first substrate and said second substrate, where said sealing frame is bonded and fixed, along both sides (i.e., a vacuum side and an atmospheric side) on abutting areas of said sealing frame, seal flit glass of one being a crystalline glass, which is crystallized under temperature lower than that of other seal flit glass; the seal flit glasses applied are dried, and then baked, provisionally, so as to remove a solvent therefrom, and also to crystallize said one crystalline seal flit glass; said first substrate and said second substrate are piled up, with putting said sealing frame between them, so that said sealing frame is positioned between the said two (2) lines of seal flit glass, facing to each other; said first substrate and said second substrate piled up with putting said seal frame therebetween are baked under temperature higher than said provisional baking; and said seal flit glass is melted for bonding thereof.

Within the method for manufacturing an image display apparatus, according to the present invention, a non-crystalline seal flit glass film may be applied between said two (2) lines of seal flit glass, being same to said other seal flit glass and thinner than film thickness of said two (2) lines of seal flit glass, which are in contact with said abutting areas of said sealing frame.

Within the method for manufacturing an image display apparatus, according to the present invention, said crystalline seal flit glass may be positioned within an inside of said sealing frame.

However, the present invention should not be restricted to the structures mentioned above and the structures described in the embodiments, which will be mentioned later, but it is needless to say that various modifications may be made but not departing from the technical idea of the present invention.

According to the present invention, it is possible to obtain an image display apparatus, in which the rear substrate and the front substrate are adhered and fixed at a predetermined positional relationship with using a seal flit glass, while putting the sealing frame therebetween, and also to provide a manufacturing method for increasing the productivity thereof.

### BRIEF DESCRIPTION OF THE DRAWINGS

Those and other objects, features and advantages of the present invention will become more readily apparent from the following detailed description when taken in conjunction with the accompanying drawings wherein:

FIG. 1 is a typical cross-section view for explaining a first embodiment of the image display apparatus, according to the present invention;

FIG. 2 is a typical cross-section view for explaining a second embodiment of the image display apparatus, according to the present invention;

FIG. 3 is a view for explaining about the dispenser for applying two (2) lines of the seal flit glass, according to the present invention;

FIGS. 4(a) to 4(d) are views for explaining about the other dispenser for applying two (2) lines of the seal flit glass, according to the present invention;

FIGS. 5(a) and 5(b) are views for explaining about the condition where independent two (2) lines of seal flit glass explained in FIG. 1 are applied on the rear substrate;

FIGS. 6(a) and 6(b) are views for explaining about the condition where the two (2) lines of seal flit glass, being connected with a thin film of seal flit glass, explained in FIG. 2, are applied on the rear substrate;

FIG. 7 is a typical cross-section view for explaining a fifth embodiment of the image display apparatus, according to the present invention;

FIG. 8 is a typical cross-section view for explaining a sixth embodiment of the image display apparatus, according to the present invention;

FIG. 9 is a typical cross-section view for explaining a seventh embodiment of the image display apparatus, according to the present invention;

FIG. 10 is a typical plane view for explaining about the detailed structures of the image display apparatus, applying a MIM type thin-film electron source therein, as one (1) example of the image display apparatus, according to the present invention;

FIGS. 11(a) and 11(b) are views for explaining an example of the image display apparatus, according to the present invention;

FIG. 12 is a typical cross-section view for showing the condition just before bonding a rear substrate and a front substrate, putting a sealing frame therebetween, with the seal fit glass;

FIG. 13 is a typical cross-section view for showing the condition where the sealing frame moves when the seal fit glass is melted;

FIG. 14 is a typical cross-section view for showing the condition where the front substrate relatively moves in parallel with the rear substrate when the seal fit glass is melted; and

FIGS. 15(a) and 15(b) are perspective views for explaining a method of assembling the rear substrate and the front substrate with using the sealing frame therewith.

### DETAILED DESCRIPTION OF THE INVENTION

Hereinafter, embodiments according to the present invention will be fully explained by referring to the attached drawings. However, herein will be given the explanation about an embodiment where the present invention is applied into a FED, but it is also applicable into other image display apparatus or similar equipments, in the similar manner.

### Embodiment 1

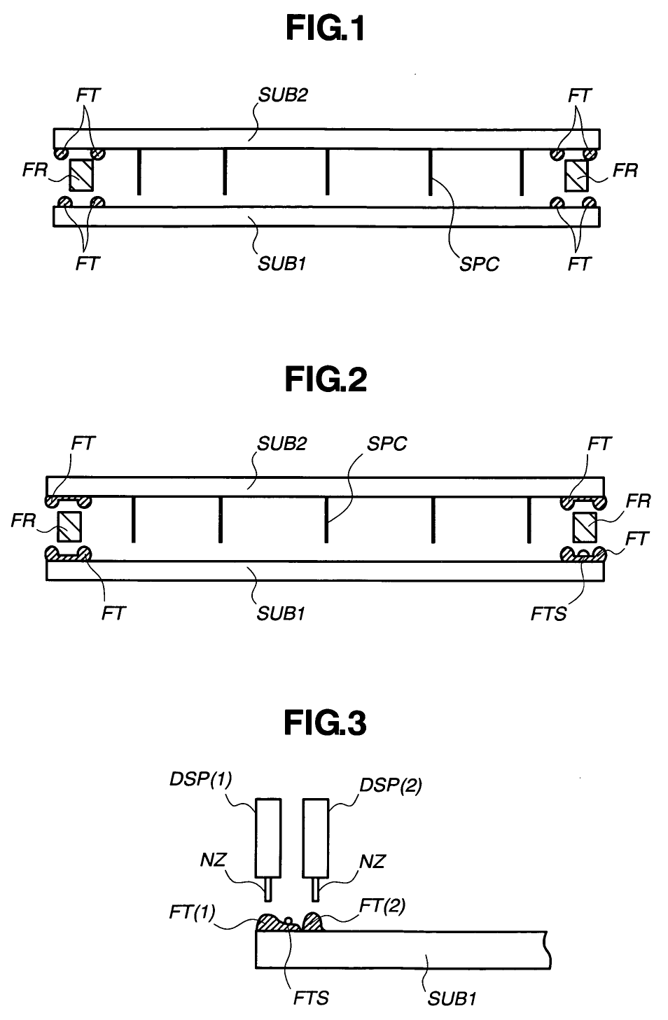

FIG. 1 is a typical cross-section view for explaining an embodiment 1 of the image display apparatus according to the present invention. In this embodiment 1, two (2) lines of seal flit glass FT are applied on inner surfaces of a rear (or rear-surface) substrate SUS1, being a first substrate, and a front (or front-surface) substrate SUS2, being a second substrate, along an area where a sealing frame FR is positioned, on both outer sides (i.e., a vacuum side and an atmospheric side). By means of those two (2) lines of seal flit glass FT are fixed the sealing frame FR, and through this sealing frame FR are adhered and fixed the said rear substrate SUS1 and the front substrate SUS2, in one body. Namely, the two (2) lines of seal flit glass FT are so applied that they sandwich the sealing frame FR on both sides thereof.

On the inner surface of the rear substrate SUS1 are made up with signal lines, scanning lines, and cathodes, etc., while on the inner surface of the front substrate SUS2 are a black matrix, fluorescent substances, anodes, etc. But those are not shown in the figure, for the purpose of simplification of the drawings. Further, a spacer SPC is provisionally fixed on the front substrate SUS2.

And, those two (2) lines of seal flit glass FT are dried, and then they are baked provisionally. The rear substrate SUS1 and the front substrate SUS2 are so disposed that the sealing frame FR is put or inserted between those two (2) lines of seal flit glass FT, which are provisionally baked, and they are affixed. Those are put into a baking furnace to be baked therein, and then the seal flit glass FT is melted down, thereby adhering the sealing frame FR and the rear substrate SUS1, and the sealing frame FR and the front substrate SUS2, respectively. They are fixed after being cooled.

Since it is in the condition of being sandwiched on both sides thereof by those two (2) lines of seal flit glass FT, the sealing frame FR can be prevented from being shifted or deformed, due to the suppressing pressure that is applied during when being baked within the baking furnace. Further, also the rear substrate SUS1 and the front substrate SUS2 will not shift into the parallel direction with each other, due to that suppressing pressure. For this reason, according to the first embodiment, it is possible to adhere and fix the rear substrate SUS1 and the front substrate SUS2, at a predetermined positional relationship thereof, with putting the sealing frame FR between them. Consequently, according to the embodiment 1, it is possible to obtain the image display apparatus of high accuracy, with preferable yield rate.

### Embodiment 2

FIG. 2 is a typical cross-section view for explaining an embodiment 2 of the image display apparatus according to the present invention. In the embodiment 2, a seal flit glass film FTS is applied between those above-mentioned two (2) lines of seal flit glass FT, in the first embodiment. The film thickness of this seal flit glass film FTS is thinner than that of those two (2) lines of seal flit glass FT, which are in contact with the said abutting area of the sealing frame FR.

This thin seal flit glass film FTS, lying between the sealing frame FR and the rear substrate SUB1 or between the sealing frame FR the front substrate SUB2, is provided for the purpose of increase adhesive strength. For this reason, according to the embodiment 2, it is possible to adhere and fix the rear substrate SUS1 and the front substrate SUS2, at a predetermined positional relationship thereof, with putting the sealing frame FR between them, much more firmly. Consequently, according to the embodiment 2, it is also possible to obtain the image display apparatus of high accuracy, with preferable yield rate.

### Embodiment 3

In the embodiment 3, one seal flit glass of those two (2) lines of seal flit glass according to the embodiment 1 is made of a crystalline material, which is crystallized under temperature lower than that of the other seal flit glass. And, the said other seal flit glass is made of a non-crystalline material. The non-crystalline seal flit glass is re-melted, again, under the baking of high temperature, so as to adhere between the sealing frame FR and the rear substrate SUB1 and between the sealing frame FR and the front substrate SUB2, and they are fixed through cooling thereof. However, the crystalline seal flit glass is crystallized under the low temperature within the provisional baking, but will not be re-melted under high temperature of the baking. For this reason, the sealing frame FR can be held at the position to be disposed, firmly. The application of this crystalline seal flit glass on the vacuum side prevents the sealing frame FR from being drawn into the vacuum side, i.e., the image displaying area; it is possible to protect the display from the ill influences thereof. Then, according to the embodiment 3, it is possible to adhere and fix the rear substrate SUS1 and the front substrate SUS2, further correctly, at the predetermined positional relationship thereof, with putting the sealing frame FR between them. Accordingly, it is possible to obtain the image display apparatus of further high accuracy, with preferable yield rate.

### Embodiment 4

In the embodiment 4, the seal flit glass film FTS is applied between those above-mentioned two (2) lines of seal flit glass FT, in the third embodiment. The film thickness of this seal flit glass film FTS is thinner than that of those two (2) lines of seal flit glass FT, which are in contact with the said abutting area of the sealing frame FR. This thin seal flit glass film FTS is a non-crystalline seal flit glass.

This thin seal flit glass film FTS, lying between the sealing frame FR and the rear substrate SUB1 or between the sealing frame FR the front substrate SUB2, is provided for the purpose of increase adhesive strength. For this reason, according to the embodiment 4, it is possible to adhere and fix the rear substrate SUS1 and the front substrate SUS2, at a predetermined positional relationship thereof, with putting the sealing frame FR between them, much more firmly. Consequently, according to the embodiment 4, it is also possible to obtain the image display apparatus of high accuracy, with preferable yield rate.

FIG. 3 is a view for showing an example of a dispenser, for applying those two (2) lines of seal flit glass FT, according to the present embodiment. This dispenser is made up with a pair of dispensers DSP(1) and PPS(2), being arranged in parallel with. And, this pair of dispensers DSP(1) and PPS(2) applies the one seal flit glass FT(1) and the other seal flit glass FT(2) while relatively moving along a peripheral edge of the rear substrate SUB1, for example, in parallel with each other. Each of the dispensers DSP(1) and PPS(2) has a nozzle NZ, respectively, and the one seal flit glass FT(1) and the other seal flit glass FT(2) are applied by means of those nozzles. Application of the seal fit glass onto the front substrate SUB2 is also same to that mentioned above.

However, in FIG. 3, the seal flit glass FT(1) discharged by the dispenser DSP(1) is made low in the viscosity thereof, so as to increase an amount thereof to be discharged from. With doing so, apart of the seal flit glass FT(1) applied on the rear substrate SUB1 flows into side of the seal flit glass FT(2), and thereby forming the thin seal flit glass film FTS. However, by adjusting the seal flit glass to be discharged by the both dispensers DSP(1) and DSP(2) equal to each other in the amount and the viscosity thereof, it is possible to apply the two (2) line of the seal flit glass, independently, as was shown in FIG. 1.

Also, application of the non-crystalline seal flit glass by the dispenser DSP(1) while applying the crystalline seal flit glass FT(2) by the dispenser DSP(2) enables the application of the independent two (2) lines of the seal flit glasses (herein, the crystalline seal flit glass is on the vacuum side). Further, the non-crystalline seal flit glass FT(1), which is discharged by the dispenser DSP(1), may be made low in the viscosity, thereby to increase the amount to be discharged from. With doing so, a part of the seal flit glass FT(1) applied on the rear substrate SUB1 flows into side of the crystalline seal flit glass FT(2), and therefore it is possible to form the thin seal flit glass film FTS.

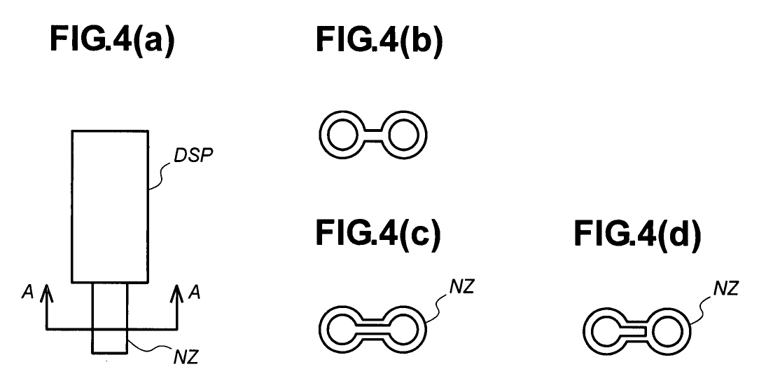

FIGS. 4(a) to 4(d) are views for showing other example of the dispenser for applying those two (2) lines of the seal flit glasses, according to the present embodiment. FIG. 4(a) is a side view of the entire thereof, and FIGS. 4(b) to 4(d) show the cross-section views of the nozzles, each being cut along A-A line in FIG. 4(a). This dispenser DSP has a one (1) body, and the nozzle NZ thereof has the structure enabling to apply those two (2) lines of the seal flit glass FT, or those two (2) lines of the seal flit glass connected with the thin seal flit glass film between them.

Thus, with using the nozzle NZ shown in FIG. 4(b), those two (2) lines of the seal flit glass FT, being independent from each other as was shown in FIG. 1, are applied on the rear substrate SUB1 or the front substrate SUB2. FIGS. 4(c) and 4(d) show the nozzle for applying those two (2) lines of the seal flit glass connected with the thin seal flit glass film FTS between them as was shown in FIG. 2.

Further, the interior of this dispenser DSP has the structure of defining an independent passage for the seal flit glass, corresponding to each of the nozzles NZ, respectively. And, to one of the passages is supplied the crystalline seal flit glass while to the other is the non-crystalline seal flit glass, respectively. With this, it is possible to apply the two (2) lines of the seal flit glass, being formed with the thin seal flit glass film, which is made of any one of the different materials thereof, in the similar manner to that explained in FIG. 3.

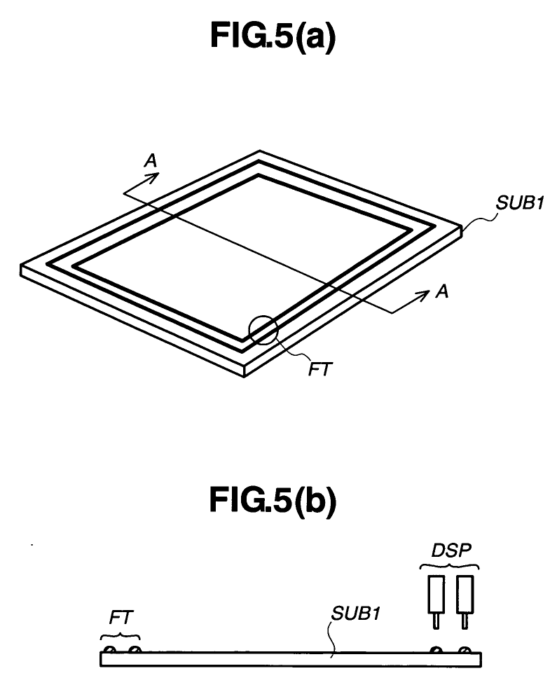

FIGS. 5(a) and 5(b) are views for explaining the condition where the two (2) lines of the seal flit glass are applied, independently, on the rear substrate, as was shown in FIG. 1. FIG. 5(a) is a perspective view, and FIG. 5(b) shows the cross-section view along the A-A line in FIG. 5(a). Herein, the two (2) lines of the seal flit glass FT, similar to that shown in FIG. 1, are applied by using the dispenser DSP shown in FIG. 3, which moves around along the outer peripheral edge of the rear substrate SUB1, in the vicinity thereof.

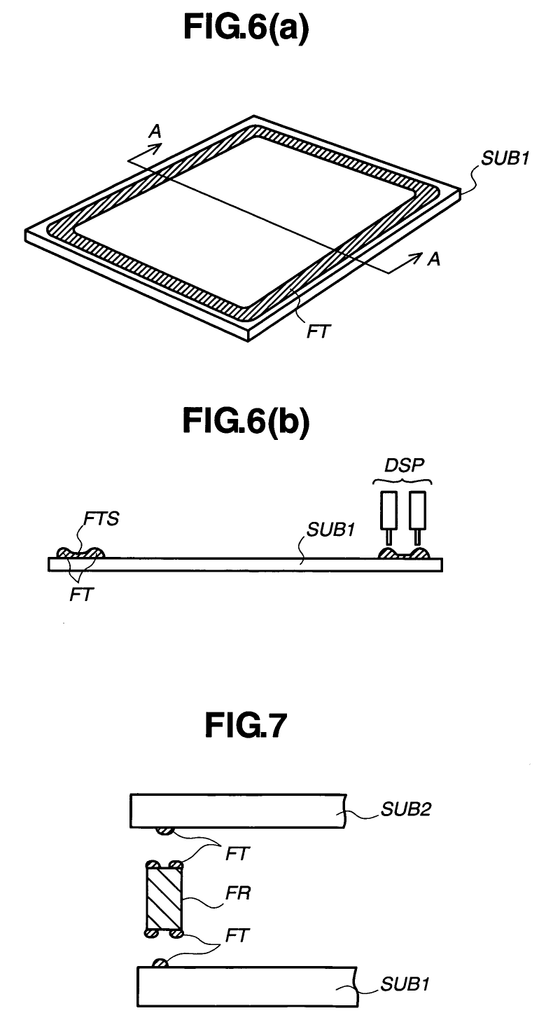

FIGS. 6(a) and 6(b) are views for explaining the condition of applying the two (2) lines of the seal flit glass, being connected with the thin seal flit glass film between them, as was explained in FIG. 2, on the rear substrate. FIG. 6(a) is a perspective view, and FIG. 6(b) shows the cross-section view along the A-A line in FIG. 6(a). Herein, the thin seal flit glass film FTS is applied between those two (2) lines of the seal flit glass, by using also the dispenser explained in FIG. 3, but letting the one dispenser to discharge the seal flit glass therefrom, much more, having viscosity lower than that of the seal flit glass discharged from the other dispenser. Further, into such application can be also used the dispenser having such the nozzle as explained in FIGS. 4(a) to (d).

As was explained in the above, according to the respective embodiments mentioned above, when welding and fixing the rear substrate SUB land the front substrate SUB2 in one (1) body, putting the sealing frame FR therebetween, with applying the seal flit glass FT, it is possible to obtain an effect of restraining the shift on the mutual or relative positions thereof. For this reason, it is possible to increase the productivity of the image display apparatus. However, the present invention should not be restricted only to the structures mentioned above, but as will be explained in an embodiment given below, also applying the seal flit glass FT on side the sealing frame FR enables to obtain the similar effect.

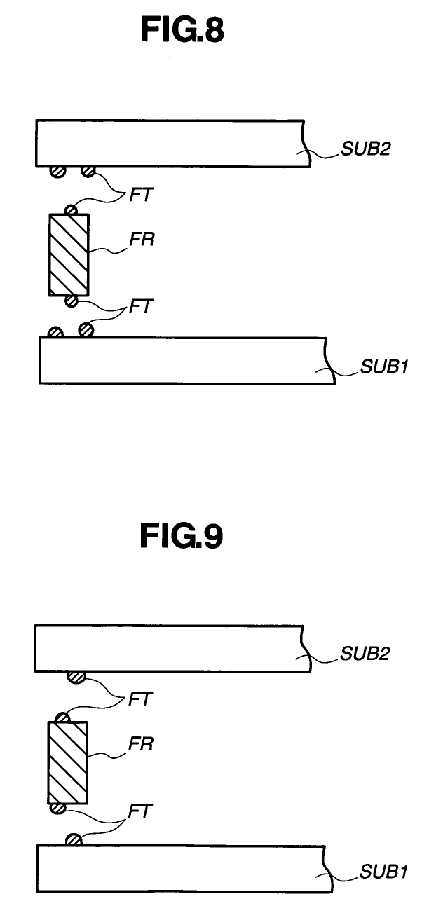

FIGS. 7 to 9 are views for explaining other embodiments according to the present invention, wherein FIG. 7 shows a typical cross-section view for explaining about an embodiment 5 of the image display apparatus, according to the present invention. Also, FIG. 8 is also a typical cross-section view for explaining about an embodiment 6 of the image display apparatus, according to the present invention. And, FIG. 9 is also a typical cross-section view for explaining about an embodiment 7 of the image display apparatus, according to the present invention.

In FIG. 7, one (1) line of the seal flit glass FT is applied on each of sides of the rear substrate SUB1 and the front substrate SUB2, respectively, while two (2) lines of seal flit glass FT are applied on side of the sealing frame FR, at the positions sandwiching the each one (1) line of the seal flit glass FT on both sides thereof. Those seal flit glasses FT applied are baked, provisionally, and the rear substrate SUB1 and the front substrate SUB2 and also the sealing frame FR are affixed onto one another at the predetermined positional relationships, to be baked under high temperature. In this instance, the one (1) line of the seal flit glass FT, each applied on side of the rear substrate SUB1 or the front substrate SUB2 comes to be similar to the thin seal flit glass film mentioned above, connecting between the two (2) lines of seal flit glass FT, which are applied on side of the sealing frame FR.

In an example shown in FIG. 8, (2) lines of the seal flit glass FT are applied on each of sides of the rear substrate SUB1 and the front substrate SUB2, respectively, while one (1) line of seal flit glass FT is applied on side of the sealing frame FR, at the positions where it is sandwiched between the (2) lines of the seal flit glass FT mentioned above. Those seal flit glasses FT applied are baked, provisionally, and the rear substrate SUB1 and the front substrate. SUB2 and also the sealing frame FR are affixed onto one another at the predetermined positional relationships, to be baked under high temperature. In this instance, the one (1) line of the seal flit glass FT applied on side of the sealing frame FR comes to be similar to the thin seal flit glass film mentioned above, connecting between the two (2) lines of seal flit glass FT, which are applied on sides of the rear substrate SUB1 and the front substrate SUB2, respectively.

In an example shown in FIG. 9, one (1) line of the seal flit glass FT is applied on each of sides of the rear substrate SUB1 and the front substrate SUB2, respectively, and also one (1) line of the seal flit glass FT is applied on side of the sealing frame FR, but at the position where it is juxtaposed with the each one (1) line of the seal flit glass FT mentioned above. Those seal flit glasses FT applied are baked, provisionally, and the rear substrate SUB1 and the front substrate SUB2 and also the sealing frame FR are affixed onto one another at the predetermined positional relationships, to be baked under high temperature. With this embodiment, since the seal flit glass FT is provided also on side of the sealing frame FR, through the provisional baking thereof, it is possible to escape from the positional shift and the deformation, as shown in FIGS. 13 and 14 mentioned above.

In the various embodiments mentioned above, it is possible to restrain the positional shift of the sealing frame FR by making the melting temperature of the seal flit glasses FT different, on an inner side (i.e., the vacuum side) and an outer side (i.e., the atmospheric side) of the sealing frame FR. In particular, it is so determined that the seal flit glass FT on the vacuum side of the sealing frame FR has a certain degree of hardness at the time point when the seal flit glass on the atmospheric side starts to melt down. With this, it is possible to prevent the sealing frame FR from shifting to the vacuum side.

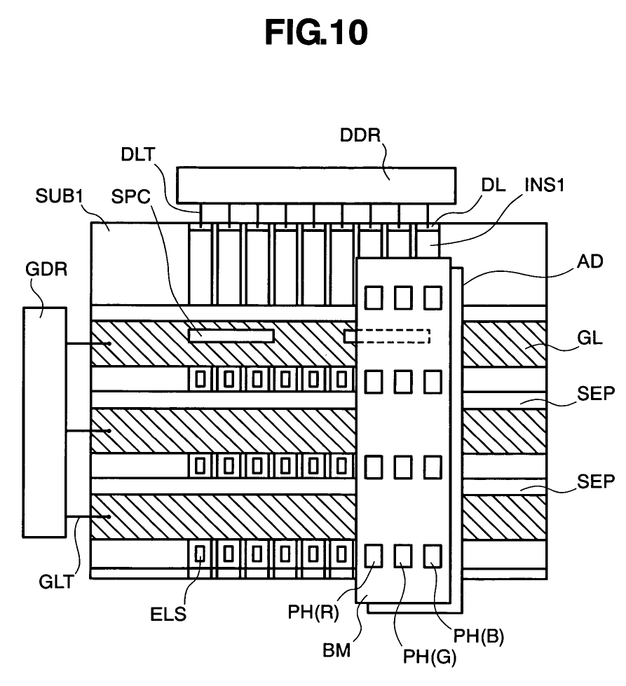

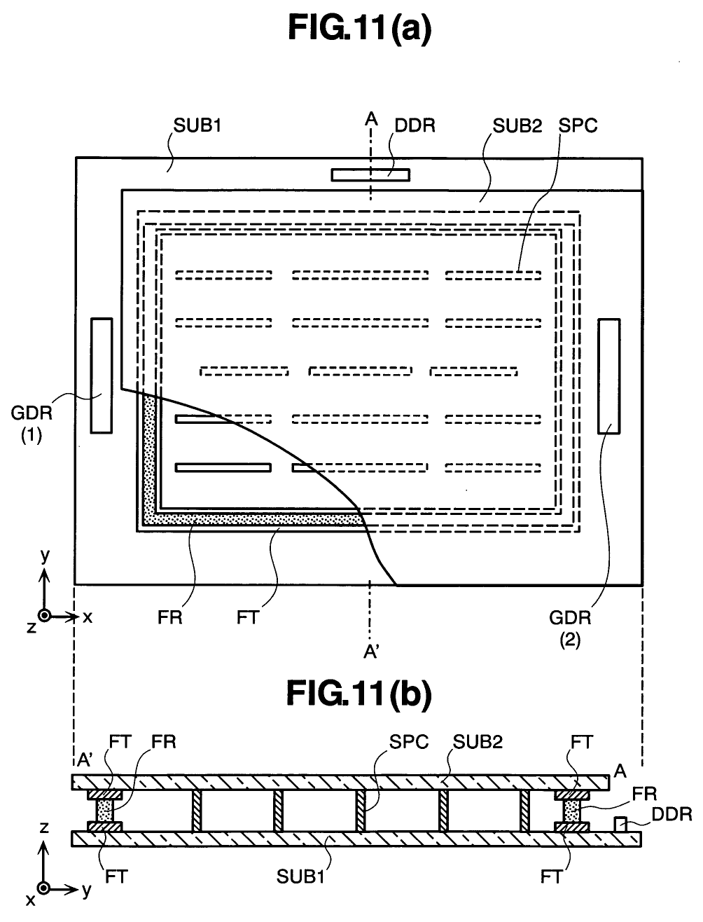

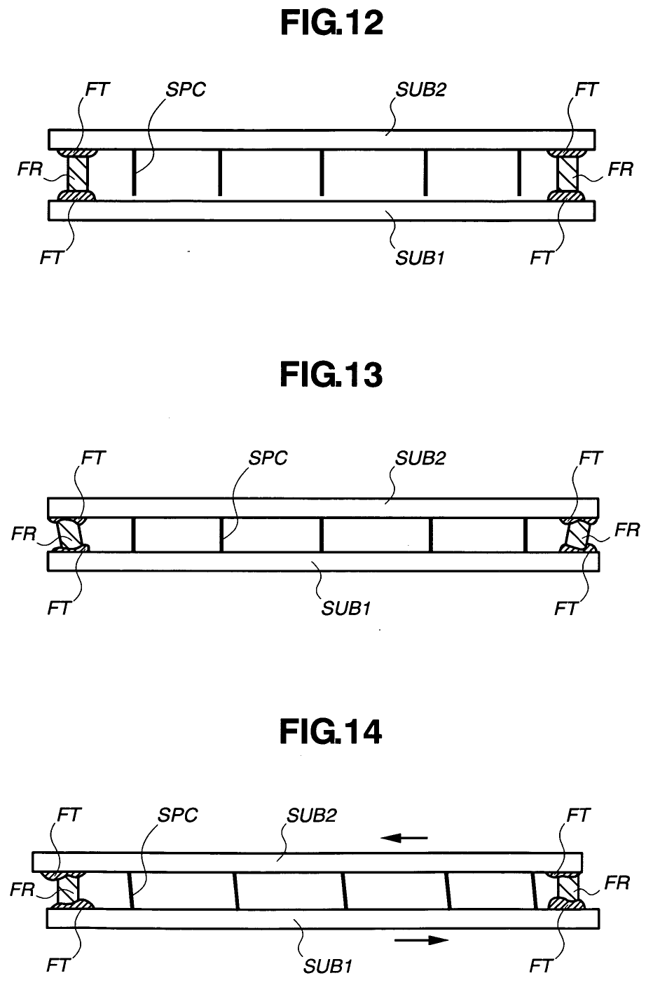

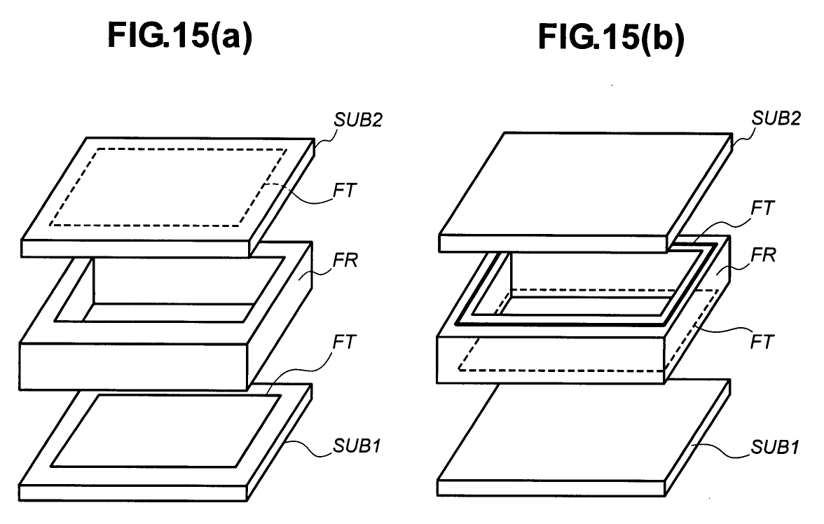

FIG. 10 is a typical plane view for explaining the detailed structures of the image display apparatus, applying an MIM-type thin-film electron source therein, as an example of the image display apparatus according to the present invention. However, in this FIG. 10, there is mainly shown a plane of a one glass substrate (i.e., a cathode substrate) having an electron source therein; thus, the rear substrate SUB1. About the other glass substrate forming the fluorescent substance, anodes, etc., thereon (also being called by a fluorescent substance substrate, a display side substrate, or a color film substrate or the like), i.e., the front substrate SUB2, apart thereof is in FIG. 10; i.e., the black matrix BM and the fluorescent substances PH(R), PH(G) and PH(B), and the anode AD, which are provided thereon (but, the entire of the front substrate SUB2 is not shown in the figure).

On the rear substrate SUB1 are formed signal lines DL connected to the signal line driver circuit DDR, and the scanning lines GL, being insulated through an insulating layer INS1 and disposed to cross the signal lines DL, etc. The scanning lines GL are connected to the scanning line driver circuit GDR. Plural electron sources, each having the signal line DL, as a first electrode, and also the thin-film electrodes of the scanning lines laminated through a tunnel insulator layer, as a second electrode (i.e., so-called a cathode ELS), are disposed in the form of an electron source array. However, a mark DLT depicts a terminal for pulling out the signal line DL, and GLT is a terminal for pulling out the scanning line GL, respectively.

Each of the fluorescent substances PH(R), PH(G) and PH(B), which are provided on the front substrate SUB2, is disposed to face to each the cathode ELS of the rear substrate SUB2, respectively. The gap between the front panel SUB2 and the rear panel SUB1 is kept at a predetermined distance by means of the space holding member SPC. The thin-film electrode (i.e., an upper electrode of the cathode ELS) is electrically divided or separated from the scanning line of the electron source array neighboring thereto, by means of a separator SEP. Into fixing the rear substrate SUB1 and the front substrate SUB2 and the sealing frame FR are applied the structures and the methods mentioned above.

The present invention maybe embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. An image display apparatus, comprising:
a rear panel having a first substrate, on which an electron source is formed;
a front panel having a second substrate, on which a fluorescence surface is formed;
a spacer provided between opposite inner surfaces of said rear panel and said front panel, so as to keep a distance between said both panels at a predetermine value; and
a sealing frame being bonded and fixed on each of the inner surfaces of said first substrate and said second, facing to each other on an outer periphery thereof, whereby a hermetically sealed inner space configured by said sealing frame and said front panel and said rear panel is lower in pressure than atmospheric pressure, wherein two (2) lines of seal flit glass applied on the inner surfaces of said first substrate and said second substrate, where said sealing frame is bonded and fixed, along a vacuum side and an atmospheric side on abutting areas of said sealing frame, whereby said sealing frame has been bonded and fixed in between said two lines of seal flit glass.

2. The image display apparatus, as is described in the claim 1, wherein a thin seal flit glass film is provided between said two (2) lines of seal flit glass, being thinner in film thickness than that of said two (2) lines of seal flit glass, which are in contact with said abutting areas of said sealing frame.

3. The image display apparatus, as is described in the claim 1, wherein one of said two (2) lines of seal flit glass is crystalline seal flit glass, which is crystallized under temperature lower than the of other seal flit glass.

4. The image display apparatus, as is described in the claim 3, wherein said other seal flit glass is non-crystalline seal flit glass.

5. The image display apparatus, as is described in the claim 2, wherein said thin seal flit glass film is made of thin seal flit glass, which is same to one or both of said two (2) lines of seal flit glass.

6. The image display apparatus, as is described in the claim 3, wherein said one seal flit glass is positioned on a vacuum side.

7. A method for manufacturing an image display apparatus, comprising: a rear panel having a first substrate, on which an electron source is formed; a front panel having a second substrate, on which a fluorescence surface is formed; a spacer implanted on between opposite inner surfaces of said rear panel and said front panel, so as to keep a distance between said both panels at a predetermine value; and a sealing frame being bonded and fixed on each of the inner surfaces of said first substrate and said second substrate, facing to each other on an outer periphery thereof, which is formed with a plural number of frame sides, each having a height regulating a distance between said first substrate and said second substrate and also abutting surfaces to be fixed on the respective inner surfaces of said first substrate and said second substrate, through adhering the above into one body with using a seal flit glass, so as to obtain a hermetically sealed inner space configured by said sealing frame and said front panel and said rear panel, being lower in pressure than atmospheric pressure, comprising the following steps of:
applying two (2) lines of seal flit glass on the inner surfaces of said first substrate and said second substrate, where said sealing frame is bonded and fixed, along a vacuum side and an atmospheric side on abutting areas of said sealing frame;
drying the seal flit glasses applied, and baking them provisionally, so as to remove a solvent therefrom;
piling up said first substrate and said second substrate, with putting said sealing frame between them, so that said sealing frame is positioned between the said two (2) lines of seal flit glass, facing to each other;
baking said first substrate and said second substrate piled up with putting said seal frame therebetween, under temperature higher than said provisional baking; and
melting said seal flit glass for bonding thereof.

8. The method for manufacturing an image display apparatus, as is described in the claim 7, further comprising a step of applying a seal flit glass film between said two (2) lines of seal flit glass, being thinner than film thickness of said two (2) lines of seal flit glass, which are in contact with said abutting areas of said sealing frame.

9. A method for manufacturing an image display apparatus, comprising: a rear panel having a first substrate, on which an electron source is formed; a front panel having a second substrate, on which a fluorescence surface is formed; a spacer implanted on between opposite inner surfaces of said rear panel and said front panel, so as to keep a distance between said both panels at a predetermine value; and a sealing frame being bonded and fixed on each of the inner surfaces of said first substrate and said second substrate, facing to each other on an outer periphery thereof, which is formed with a plural number of frame sides, each having a height regulating a distance between said first substrate and said second substrate and also abutting surfaces to be fixed on the respective inner surfaces of said first substrate and said second substrate, through adhering the above into one body with using a seal flit glass, so as to obtain a hermetically sealed inner space configured by said sealing frame and said front panel and said rear panel, being lower in pressure than atmospheric pressure, comprising the following steps of:
applying two (2) lines of seal flit glass on the inner surfaces of said first substrate and said second substrate, where said sealing frame is bonded and fixed, along a vacuum side and an atmospheric side on abutting areas of said sealing frame, seal flit glass of one being a crystalline glass, which is crystallized under temperature lower than that of other seal flit glass;
drying the seal flit glasses applied, and baking them provisionally, so as to remove a solvent therefrom, and also to crystallize said one crystalline seal flit glass;
piling up said first substrate and said second substrate, with putting said sealing frame between them, so that said sealing frame is positioned between the said two (2) lines of seal flit glass, facing to each other;
baking said first substrate and said second substrate piled up with putting said seal frame therebetween, under temperature higher than said provisional baking; and
melting said seal flit glass for bonding thereof.

10. The method for manufacturing an image display apparatus, as is described in the claim 9, further comprising a step of applying a non-crystalline seal flit glass film between said two (2) lines of seal flit glass, being same to said other seal flit glass and thinner than film thickness of said two (2) lines of seal flit glass, which are in contact with said abutting areas of said sealing frame.

11. The method for manufacturing an image display apparatus, as is described in the claim 9, wherein said crystalline seal flit glass is positioned within an inside of said sealing frame.
